(19) United States
(12) Patent Application Publication
(10) Pub. No.: US 2022/0350305 A1
(43) Pub. Date: Nov. 3, 2022

(54) DIGITAL IMAGE TRANSFORMATION TO REDUCE EFFECTS OF SCATTER DURING DIGITAL LIGHT PROCESSING-STYLE MANUFACTURING

(71) Applicant: 3DFORTIFY INC., Boston, MA (US)

(72) Inventors: Randall M. Erb, Newton, MA (US); Philip Michael Lambert, Cambridge, MA (US); Alan Charles Cramer, Lynnfield, MA (US)

(21) Appl. No.: 17/717,019

(22) Filed: Apr. 8, 2022

Related U.S. Application Data
(60) Provisional application No. 63/173,324, filed on Apr. 9, 2021.
(60) Provisional application No. 63/173,324, filed on Apr. 9, 2021.

(51) Int. Cl. G05B 19/4093; B33Y 30/00; B33Y 50/00; B29C 64/393; B29C 64/124

(52) U.S. Cl. CPC G05B 19/40931; B33Y 30/00; B33Y 50/00; B29C 64/393; B29C 64/124; G05B 2219/49023

(57) ABSTRACT

Systems and methods for producing more accurate, intricate structures via digital light processing additive manufacturing are provided. One or more digital transformations, or filters, are applied to 2D-images used to print the part to help eliminate the effects of scatter. The digital transformations can lead to higher doses of light to be applied to edges and smaller features while limiting an amount of exposure to light of larger features to avoid over-curing of the larger features. This can help keep the integrity of certain designs, such as lattices and other structures that are intended to have some porosity. The digital transformations can also be used in a diagnostic manner to help provide feedback on performance.

### CROSS-REFERENCE TO RELATED APPLICATIONS

This application claims benefit of priority from U.S. Provisional Application No. 63/172,654, filed Apr. 8, 2021, and U.S. Provisional Application No. 63/173,324, filed Apr. 9, 2021, the disclosures of which are hereby incorporated by reference herein in their entireties.

### FIELD

The present disclosure relates to systems and methods for reducing the negative effects of scatter that occur during additive manufacturing through photopolymerization, and more particularly relates to transforming 2D images used in conjunction with such manufacturing to provide optimal dosing of light or photons when printing a slice of the final 3D image characterized by such 2D image.

### BACKGROUND

Photopolymer additive manufacturing printers project 2D images with a selected slice thickness that represent slices of a 3D model. Light then cures the photopolymer resin, changing the state of the photopolymer resin from liquid to solid. These photopolymer resins, particularly particle-filled resins, scatter the light, which diffuses the light signal, resulting in printing errors if this scattering effect is not taken into account.

While attempts have been made to address the adverse effects of scatter, current practices in digital light processing (DLP) printing do not completely address scatter that occurs by projecting light into at least certain photoresins, including particle-filled resins used at least with respect to tooling and radio frequency (RF) applications. Scatter can, for example, significantly reduce the number of available photons for curing photoresins across high-precision components of printed features, most notably edge boundaries and small features.

Scatter need not be uniform across the face of a resin. Homogeneity of scattering effects often varies with the content of the target photoresin. A known approach to combat the scattering effect when printing complex and high-precision geometries in photoresins is to either optimize the delivered photon dosage for large features, often sacrificing the ability to resolve small features, or to optimize the delivered dosage for small features, often over-curing larger features within the geometry. Focusing on providing enough light to properly render small features and edges is typically achieved by increasing the total light energy applied to the photoresin as a whole, usually by increasing the intensity of the provided light, the duration of the curing process, or combinations thereof. Both techniques result in the over-curing of non-small feature/non-edge portions of the part being printed. Over-curing is a significant problem, especially for geometries that have internal vacancies/holes/porosity, such as RF Gradient Index (GRIN) lenses and/or lattices. This over-cure can result in through-curing in the z-direction into these desired vacancies, obscuring or even completely closing these features. Struts and spaces in the design are thus not rendered as intended. Over-curing can also result in a degradation of desirable mechanical properties of a printed part, including embrittlement, among other undesirable impacts of current techniques.

Accordingly, there is a need for systems and methods to regulate light application during a photopolymerization additive manufacturing process that reduces and/or eliminates the detrimental effects of scatter to allow for parts to be properly rendered without undesirable curing, under-curing, and/or over-curing in portions of the printed parts.

### SUMMARY

The example embodiments disclosed herein relate to the mitigation of scattering effects in additive manufacturing systems and methods utilizing photopolymerization. According to at least one aspect of the present disclosure, an additive manufacturing device includes a tank, a build plate, a light projector, and a processor. The tank is configured to have a photopolymer resin material disposed in it. The build plate is disposed above the tank and is configured to at least move along a vertical axis, away from the tank. The light projector is configured to project an image of a part to be printed towards the tank. The processor is configured to apply one or more digital transformations to a build file. These digital transformations provide an adjusted light intensity for a projected dosage at one or more designated pixels of the image projected by the digital light projector. The adjusted light intensity is based on an untransformed initial image, which is constructed prior to application of the one or more digital transformations to one or more nearby pixels of the one or more designated pixels. The projected dosage for the one or more designated pixels is inversely proportional to the untransformed initial image intensity for the one or more nearby pixels.

In some embodiments, the build file includes a plurality of slice images that comprise the image of the part to be printed. The processor can further be configured to remove at least one of one or more binary images or one or more greyscale images from the build file. The processor can further be configured to replace at least one of the at least one removed binary image or one removed greyscale image with an at least one transformed slice image of the plurality of slice images.

The processor can be further configured to generate a plurality of slice images that include the image of the part to be printed. The processor can also generate instructions for driving the additive manufacturing device for the part to be included as part of the build file. According to other or the same embodiments, the processor can apply the one or more digital transformations to at least one slice image of the plurality of slice images.

In other or the same embodiments, applying one or more digital transformations to a build file to adjust a light intensity can further include amplifying light intensity at the one or more designated pixels. The one or more designated pixels can include one or more pixels located at at least one of a geometric edge of the part or a smaller feature of the part. The one or more digital transformations may further include one or more kernels, and the one or more kernels can include an anti-gaussian kernel, a modified Sorbel kernel, and/or an unsharp masking kernel.

According to other or the same embodiments, applying one or more digital transformations to a build file to adjust a light intensity at one or more designated pixels of the image projected by the digital light projector can include utilizing a sequence of images for different exposure times to produce a single layer of the printed part. Additionally, or alternatively, applying one or more digital transformations to a build file to adjust a light intensity at one or more designated pixels of the image projected by the digital light projector can include utilizing a machine-learning based approach to applying digital transformations. The approach can include comparing large datasets of transformed images and associated outcomes to make predictions for a transformed image of the build file to produce a single layer of the printed part.

According to at least one aspect of the present disclosure, a method of printing includes applying one or more digital transformations to a build file. The application of the digital transformations provide an adjusted light intensity for a projected dosage at one or more designated pixels of the image projected by a digital light projector. Further, the adjusted light intensity is based on an untransformed initial image prior to application of the one or more digital transformations to one or more nearby pixels of the one or more designated pixels, and the projected dosage for the one or more designated pixels is inversely proportional to an untransformed initial image for the one or more nearby pixels. The build file includes information about the part to be printed.

In at least some embodiments, the method can include applying the one or more digital transformations to at least one slice image of a plurality of slice images of the build file. The plurality of slice images can include the image of the part to be printed in at least some of such embodiments, and the at least one slice image of the plurality of slice images can be reprocessed in at least some embodiments to account for the applied one or more digital transformations. Further, in at least some such embodiments, re-processing the at least one slice image can include removing at least one of one or more binary images or one or more greyscale images from the build file, as well as replacing at least one of the at least one removed binary image or one removed greyscale image with the at least re-processed slice image in the plurality of slice images.

The method of printing a 3D part can further include processing the build in a variety of manners. For example, by generating a plurality of slice images for the part to be included as part of the build file. By way of further example, by generating instructions for driving the additive manufacturing device for the part to be included as part of the build file. By way of still further example, by exporting the processed build file to a controller to operate the DLP printer.

The one or more designated pixels of the method of printing can include one or more pixels located at at least one of a geometric edge of the part or a smaller feature of the part. The action of applying one or more digital transformations to a build file to provide an adjusted light intensity at one or more designated pixels of the image projected by the digital light projector can further include utilizing a sequence of images for different exposure times to produce a single layer of the printed part.

In at least some embodiments of a method for printing a 3D part, applying one or more digital transformations to a build file to provide an adjusted light intensity at one or more designated pixels of the image projected by the digital light projector can include utilizing an iterative approach. The iterative approach can update an educated determination about the light intensity to be used in conjunction with a transformed image of the build file to produce a single layer of the printed part.

According to at least one aspect of the present disclosure, a method of printing includes applying one or more digital transformations to a build file for a part to be printed. The transformations applied adjust a projected dosage of light at one or more designated pixels of an image to be projected in conjunction with printing the part to yield a desired dosage of light at the one or more designated pixels during printing. The desired dosage of light is based on a light intensity of an untransformed initial image intended to be supplied to one or more nearby pixels of the one or more designated pixels, and the desired dosage of light for the one or more designated pixels is inversely proportional to the intended light intensity for the one or more nearby pixels. The method further includes performing digital light processing printing based on the build file to print the part.

According to some embodiments of a method of printing according to the present disclosure, applying one or more digital transformations to a build file can include utilizing a sequence of images for different exposure times to produce a single layer of the printed part. According to other or the same embodiments, applying the digital transformation(s) to a build file to provide an adjusted light intensity at one or more designated pixels of the image projected by the digital light projector can further include utilizing an iterative approach that updates an educated determination about the light intensity to be used in conjunction with a transformed image of the build file to produce a single layer of the printed part. Still further, applying one or more digital transformations to a build file to provide an adjusted light intensity at one or more designated pixels of the image projected by the digital light projector can include utilizing a machine-learning based approach for digital transformation that compares large datasets of transformed images and associated outcomes to make predictions for a transformed image of the build file to produce a single layer of the printed part.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to illustrate at least some principles of the disclosure:

FIG. 1 is a schematic side view of an idealized printing solution wherein there is no scattering effect;

FIGS. 2A and 2B are schematic side views of a desired printing solution absent scatter, contrasted with a resultant print using prior art methods that do not address the scattering problem;

FIG. 3 is a schematic side view of over-curing that results from the overexposure of larger features according to prior art systems and methods, with FIG. 3A further including a magnified portion of the schematic image;

FIG. 4 is a graph illustrating the difference between a desired dosage and a projected dosage in a pixel array due to scattering according to prior art systems and methods;

FIG. 5 is another graph illustrating the difference between a desired dosage and a projected dosage in a pixel array due to scattering according to prior art systems and methods;

FIG. 6A is a perspective view of an example GRIN device that can be developed and printed using the additive manufacturing systems and methods disclosed herein:

FIG. 6B is a 2D top view image of an example GRIN device developed using the additive manufacturing systems and methods disclosed herein;

FIG. 7A is a top perspective view of one example of a GRIN device developed using prior art additive manufacturing systems and methods;

FIG. 7B a side perspective view of another example of a GRIN device developed using prior art additive manufacturing systems and methods;

FIG. 7C is the side perspective view of the GRIN device of FIG. 7B having needles inserted therein;

FIG. 8A is a 2D image of a slice of a GRIN device that utilizes a prior art projected dosage;

FIG. 8B is a magnified portion of the 2D image of FIG. 8A;

FIG. 8C is a 2D image of a slice of a GRIN device that utilizes a dosage according to a kernel applied in accordance with at least some embodiments of the systems and methods described herein;

FIG. 8D is a magnified portion of the 2D image of FIG. 8C;

FIG. 8E is the magnified portion of the 2D image of FIG. 8D, illustrating various greyscale values that result from application of the kernel;

FIG. 8F is the magnified portion of the 2D image of FIG. 8D utilizing an alternative approach according to at least one embodiment for controlling pixel intensity on a per-layer basis;

FIG. 8G is a magnified 2D image of a layer of a GRIN device, and associated sequential images used to produce that 2D image of the layer of the GRIN device;

FIG. 9 is a graph illustrating the difference between a desired dosage and a projected dosage in a pixel array due to scattering according to at least some embodiments of the disclosure herein;

FIG. 10A is a front perspective view of an example of a GRIN device developed using additive manufacturing and at least one kernel of the at least some embodiments of the systems and methods described herein;

FIG. 10B is a magnified section view of an internal lattice of the GRIN device of FIG. 10A, illustrating a near-nominal structure having crisp edges;

FIG. 10C is a magnified section view of an internal lattice of a GRIN device printed without use of a kernel;

FIG. 11 is a graph illustrating a projected dosage in a pixel array according to at least some embodiments of the disclosure herein;

FIG. 12A is a graph illustrating a brute force input for a projected pixel intensity in relation to a standard input according to at least some embodiments of the disclosure herein;

FIG. 12B is a graph illustrating a brute force output and a standard output in relation to a standard input for a projected pixel intensity where the brute-force output is determined from a brute-force input according to at least some embodiments of the disclosure herein;

FIG. 13 is a flowchart illustrating a work flow for known methods of 3D printing;

FIG. 14 is a flowchart illustrating one exemplary embodiment of a workflow for methods of 3D printing according to at least some embodiments of the disclosure herein;

FIG. 15 is a flowchart illustrating another exemplary embodiment of a work flow for methods of 3D printing according to at least some embodiments of the disclosure herein;

FIG. 16A is a gyroid working curve build set showing the effects of multiple input kernels according to at least some diagnostic embodiments of the present disclosure;

FIG. 16B is a single magnified image of the gyroid working curve build set of FIG. 16A according to at least some diagnostic embodiments of the present disclosure;

FIG. 17 is a flowchart illustrating still another exemplary embodiment of a work flow for methods of 3D printing according to at least some embodiments of the disclosure herein; and

FIG. 18 is a schematic representation of a computer system upon which certain transformations and instructions for driving the additive manufacturing device can be implemented according to at least some embodiments of the disclosure herein.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Terms commonly known to those skilled in the art may be used interchangeably herein. Further, like-numbered components and the like across embodiments generally have similar features unless otherwise stated or a person skilled in the art would appreciate differences based on the present disclosure and his/her knowledge.

Because a person skilled in the art will generally understand how DLP additive manufacturing works, the present disclosure does not provide details related to the same. A person skilled in the art will understand how to apply the principles, techniques, and the like disclosed herein to DLP processes and DLP printers. Some non-limiting examples of DLP printers and techniques with which the present disclosure can be used include those provided for in U.S. Pat. No. 10,703,052, entitled “Additive Manufacturing of Discontinuous Fiber Composites Using Magnetic Fields,” U.S. Pat. No. 10,732,521, entitled “Systems and Methods for Alignment of Anisotropic Inclusions in Additive Manufacturing Processes,” and the FLUX 3D printer series, including the FLUX ONE 3D printer, manufactured by 3DFortify Inc. of Boston, Mass. (further details provided for at http://3dfortify.com/ and related web pages), the contents of all being incorporated by reference herein in their entireties.

The present disclosure provides for systems and methods that combat the adverse effects of scatter during photopolymer based additive manufacturing processes, including digital light processing (DLP), stereolithography (SLA), and liquid crystal display (LCD) techniques. The systems and methods include applying one or more digital transformations to be applied to an untransformed initial image, the transformations sometimes referred to as filters, to deliver near-optimal dosage to a majority, up to an entirety, of a printed part, including its edges, small features, and large features concurrently in complex geometries. In at least some instances, this includes convolving the input image with an appropriate kernel that acts on a series of image slices to mitigate or inverse the effects of scattering, resulting in a more precise geometric representation of the model. The inversion is such that the intensity of the light delivered from each pixel location of the projector in the digitally transformed projection image has an intensity that is inversely proportional to the effective intensity of nearby pixels in the original projection image. This inverse proportionality operates according to some embodiments in relation to the density of “ON” voxels within a given space, referred to herein as an “antidensity” transformation. In embodiments wherein photoresins have additives, the effects of scatter can be particularly pronounced, due at least in part to the size and/or density of fiber additives. Different additives can have different impacts, with magnetic fibers being one non-limiting example of an additive that negatively enhances the effects of scatter. By way of contrast to the inverse proportionality, the intensity of the light that ends up being directed to a voxel in prior art techniques is typically equalized across all voxels to be printed, independent of the state of nearby voxels, sometimes referred to “nearest neighbor” voxels.

As described herein, the present disclosures provide for a new methodology to apply specific types of digital transformations, including kernels, to projected image files in photopolymer printing to fight the detrimental effects of scatter that occur in many photopolymer resins. According to at least some of such embodiments, including some described in detail below, a photopolymer printing technique includes DLP additive manufacturing processes. As a result, certain geometries (e.g., such as RF lenses) can be printed successfully (e.g., without aspects of the part being under- or over-cured to an undesirable level) using DLP additive manufacturing where such parts previously could not be printed successfully using previously known DLP techniques.

Without use of the disclosed systems and methods, scatter will typically cause lower light dosage levels near geometric edges of a printed part and throughout smaller features. If one merely projects an untransformed initial image in an additive manufacturing process, the scattering effects will result in a part that varies from a desired outcome. The digital transformations provided for herein are designed to generally amplify the light intensity near geometric edges and throughout smaller features to offset this phenomenon. In some embodiments, the digital transformations employed include one or more kernels. Convolving a kernel with the input image produces a new image that, when projected and scattered in the material, results in a more precise representation of the desired geometry. The application of kernels causes the projected images to show greyscale brightening near edges, and may also be applied to show greyscale brightening in conjunction with small features of the printed part. This is notably different than technologies that use greyscaling in which image adjustments are made to gradate the amount of light across an edge or boundary. The disclosed systems and methods transform images and greyscales in a manner that is inversely proportional to the amount of light associated with nearby on-pixel(s) in the untransformed projection image, including antidensity transformations. A nearby pixel or voxel, as used herein, can be one that is within one (1) pixel/voxel, five (5) pixels/voxels, 10 pixels/voxels, 20 pixels/voxels, 40 pixels/voxels, or 80 pixels/voxels, or any number in-between, depending on a variety of factors understood by a person skilled in the art in view of the present disclosures.

Several types of kernels have been tested and proven that can be used in this methodology. In combination, the kernels, as well as other digital transformations provided for herein or otherwise derivable from the present disclosures, can provide a toolbox or kit of digital transformations that can be used to transform images in a desired manner prior to, or in conjunction with, delivering light for curing. This approach can also be used to “characterize” the scatter characteristics of the resin system in question.

At least some embodiments of the systems and methods disclosed herein manipulate the projected image in DLP printing to exhibit higher “Projected Dosage” at the edges, and in other or the same embodiments this occurs across the small features relative to the larger features in each projected image, which in turn combats the adverse effect of natural light scatter within many photoresins, especially particle-filled photoresins. According to at least some embodiments, the photoresins used in the present disclosure can include one or more functional additives (e.g., ceramic particles, magnetic particles), which can increase scatter. In such embodiments, this additive results in projected images with brighter edges and possibly brighter small features. Without the provided for digital transformations, RF GRIN devices, or devices of similar lattice compositions, could not be produced with a desired mechanical efficacy. At least some embodiments of the systems and methods disclosed herein can be applied to any printed part that includes edges, and thus are not limited to use in conjunction with lattice compositions and the like even though such compositions are illustrated herein in some exemplary embodiments.

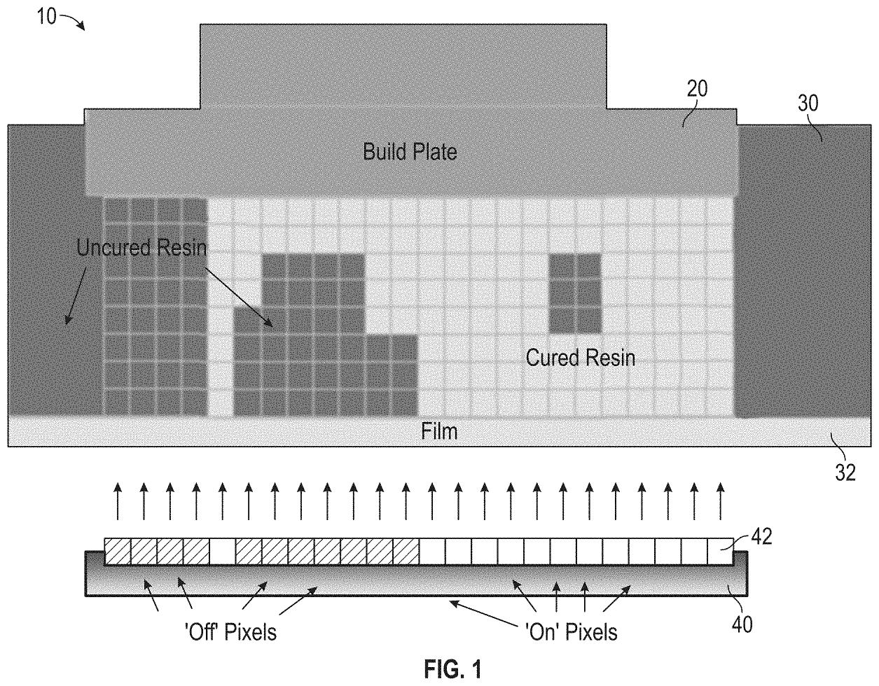

FIG. 1 shows what some may consider to be an ideal solution for the scattering problem in photopolymer resin printing. As shown, this image depicts a DLP printing solution, e.g., a DLP 3D printer 10, that includes a build plate 20, a film 32 disposed in a reservoir 30, and a light source 40 having the ability to provide light in discrete quanta of pixels 42, which a person skilled in the art will appreciate are common features of a DLP 3D printer. In the illustrated embodiment, in what may be considered an “ideal solution, “ON” pixels (the pixels 42 denoted as unshaded; “OFF” pixels are illustrated as pixels 42 that are shaded) will cure the corresponding voxel in its entirety. Absent a form of active or passive error correction to mitigate the scattering problem however, this solution is not achievable by simply projecting an untransformed initial image, where the curing light from the light source 40 onto each of the “ON” pixels. In practice, light gets bounced and scattered in photoresins, especially those that have particle filler (e.g., functional additives, such as magnetic components). Scattering results in two primary effects that degrade the mechanical properties of printed parts, ultimately arising from particles in the targeted voxels physically scattering photons into neighboring, untargeted voxels. As a result, fewer photons ultimately impart their energy to the targeted voxel, instead bleeding this curing energy into neighboring voxels. Accordingly, there is an under-curing of the targeted voxels, and an over-curing of the neighboring voxels.

According to at least some embodiments of the present disclosure, both bottom-up printer designs, such as that shown in FIG. 1 in which a projector is disposed below a reservoir having resin disposed therein and a build plate, and top-down printer designs (not shown), can be utilized with the systems and methods disclosed herein. The resin can include one or more functional additives disposed in it. The projector can be configured in manners known to those skilled in the art. This can include, for example, a digital light projector that includes a digital micromirror device having a plurality of micromirrors. The micromirrors can each be configured to toggle between an on position and an off position to reflect a pixel of the image towards the reservoir or tank. A person skilled in the art will appreciate how a top-down DLP printer design would be different than the illustrated implementation of FIG. 1 (and other figures herein), as well as understand how the teachings of the present disclosure can be used in conjunction with a top-down DLP printer. By way of non-limiting example, a top-down printer design can also include a build plate, a film, a reservoir, and a light source, among other features. In some such embodiments, a projector and/or light source can be located above a reservoir, and the build plate can move downwards rather than upwards during printing. In conjunction with such top-down printing, antidensity transformations of the nature provided for herein or otherwise derivable from the present disclosures can be used to improving the accuracy and completeness of the printed.

This simultaneous over-curing and under-curing problem presents minimal issue across a broad enough surface to cure. This is because the photons that are scattered away from the targeted first voxel are scattered into a second voxel that also requires curing, and the photons aimed for the second voxel are also scattered into the first voxel, netting a canceling effect. Thus, this scattering problem is most prevalent in areas of a printed part where the targeted voxels are not surrounded by other targeted voxels in the plane of curing, most often occurring in edges or small features of a printed part.

In a simplified notation for the scattering problem that is helpful in articulating solutions thereto, a “Projected Dosage” is often much smaller than a “Received Dosage” for edges and small features. Each of these terms is addressed in comparison to a “Desired Dosage,” which represents the dosage each voxel needs to receive to ideally print the desired part. More specifically, “Projected Dosage” represents the amount of energy that is sent from the pixel (e.g., the pixel(s) 42 of FIG. 1) of the projector (e.g., the light source 40 of FIG. 1) into the material before scatter occurs. “Received Dosage” represents the amount of energy that a voxel within the material actually receives after scatter occurs. “Desired Dosage” represents the cure that most accurately resolves a feature through polymerization. In the event that the projected dosage matches the untransformed initial image, the received dosage at each voxel will not typically match the desired dosage. More than the desired cure leads to over-cure and possibly material embrittlement. Less than the desired cure leads to insufficient polymerization for the feature to survive the printing and post-processing processes. The desired dosage may represent a working window of dosage, not just a specific value.

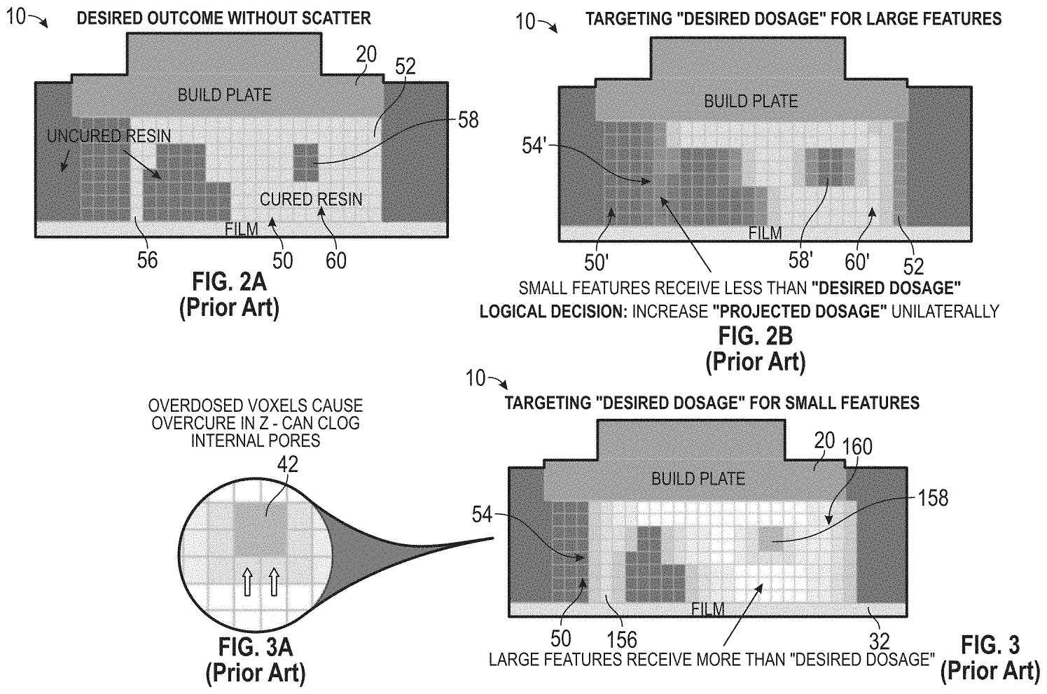

While the full dosage is expected to be received by the printed part based on an untransformed initial image, an effect of scattering is that the dosage is not expected to be properly distributed to the correct voxels, thus Received Dosage is unlikely to equal the Desired Dosage. Turning to the illustration of FIGS. 2A and 2B, which still utilize the build plate 20 and the film 32, a desired printing solution absent scatter (FIG. 2A) is contrasted with a resultant print using prior art methods that do not address the scattering problem (FIG. 2B). In FIG. 2A, each voxel 52 of a part 50 to be printed receives the Desired Dosage, including edges 54, small features 56, 58, and larger features 60. By contrast, FIG. 2B is printed using prior art solutions that optimize the Projected Dosage for large features 60′ of a part 50′ to be printed, resulting in under-curing of edges 54′ and small features 56′, 58′ due to scatter. Accordingly, as shown in FIG. 2B, the small feature 56′ receives less than the desired dosage, as does the small, six voxel (or pixel when considered as a 2D-image that is printed to form a layer of the printed part) rectangular portion small feature 58′.

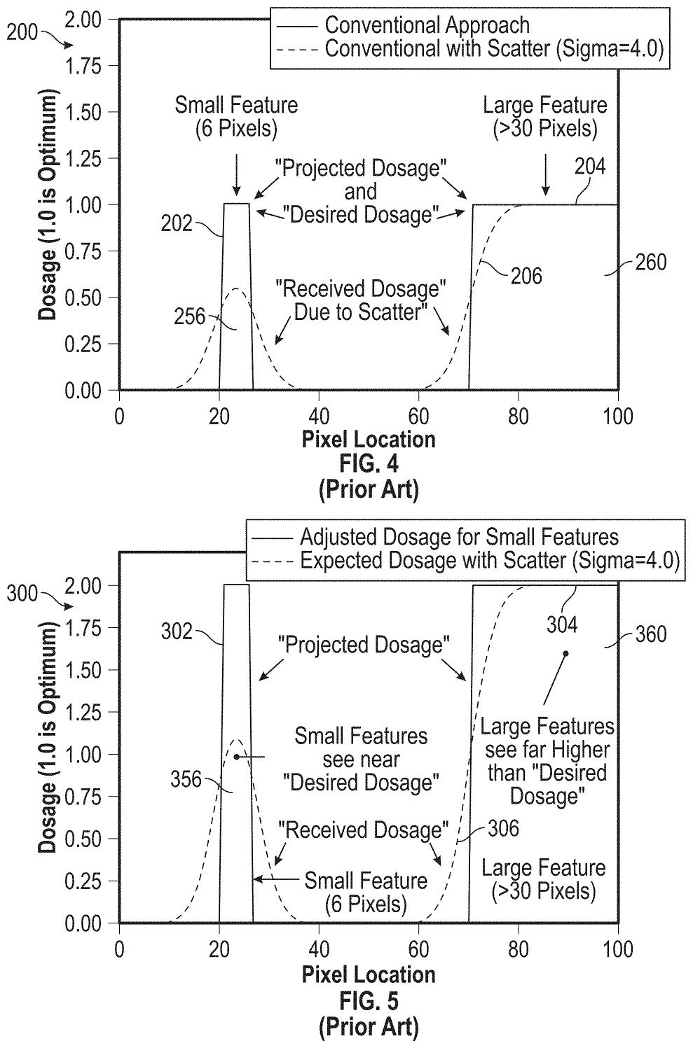

In another prior art solution, this time shown as FIG. 3, and again still using the build plate 20 and the film 32, projected and delivered dosage are increased across a plane of a part 156 to be printed, for instance by increasing light intensity and/or increasing exposure time. This effectively targets the “desired dosage” in smaller features 156, 158, however, results in larger features 160 exhibiting a “received dosage” that is over the “desired dosage” (i.e., the large features 160 get over-cured). This results in an overexposing of the larger features 160 with photons that can result in poor mechanical outcomes or, more specifically for RF applications, can result in over-cure in the z-dimension that closes up internal geometric porosity. As shown, while the edges 154 and the smaller features 156, 158 now have closer to a “desired dosage,” the larger features 160 have received significantly more than the “desired dosage.”

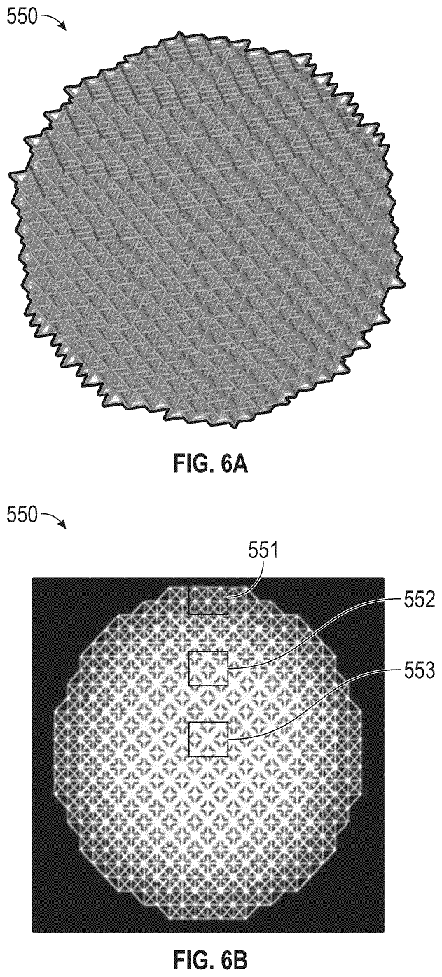

To additionally illustrate this, consider a chart 200 of FIG. 4. In this chart 200, lines 202, 204 that form more rectangular shapes represent the “desired dosage” that the user wants to be delivered to the features to get the desired cure. If the user tunes the “projected dosage” to deliver the “desired dosage” to large features 260, then the “received dosage,” illustrated as a more curved line 206 (as compared to the “desired dosage” lines 202, 204), experienced at the site of small features 256 (and edges) is well-below optimal.

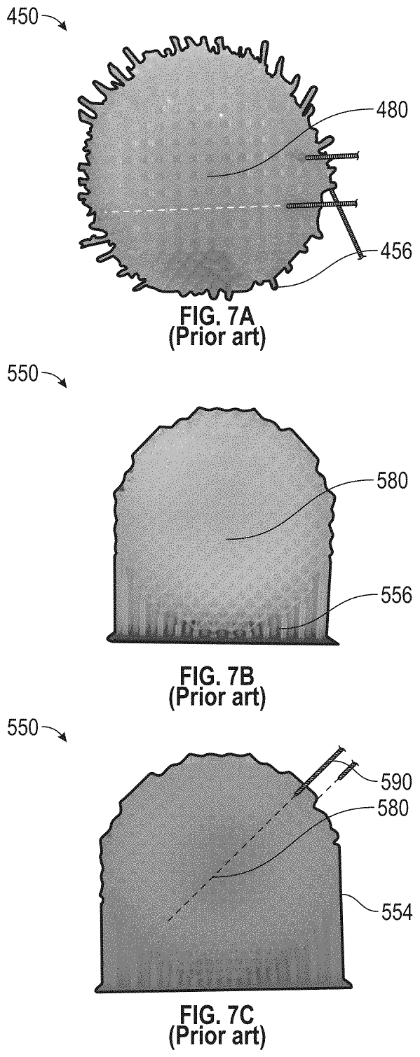

If instead the user adjusts the “projected dosage,” as shown in FIG. 5, with lines 302, 304 that form more rectangular shapes, to deliver the “desired dosage” to smaller features 356, then larger features 360 receive well-over the “desired dosage,” with again a “received dosage” line 306 being illustrated as the more curved line (as compared to the “desired dosage” lines 302, 304).

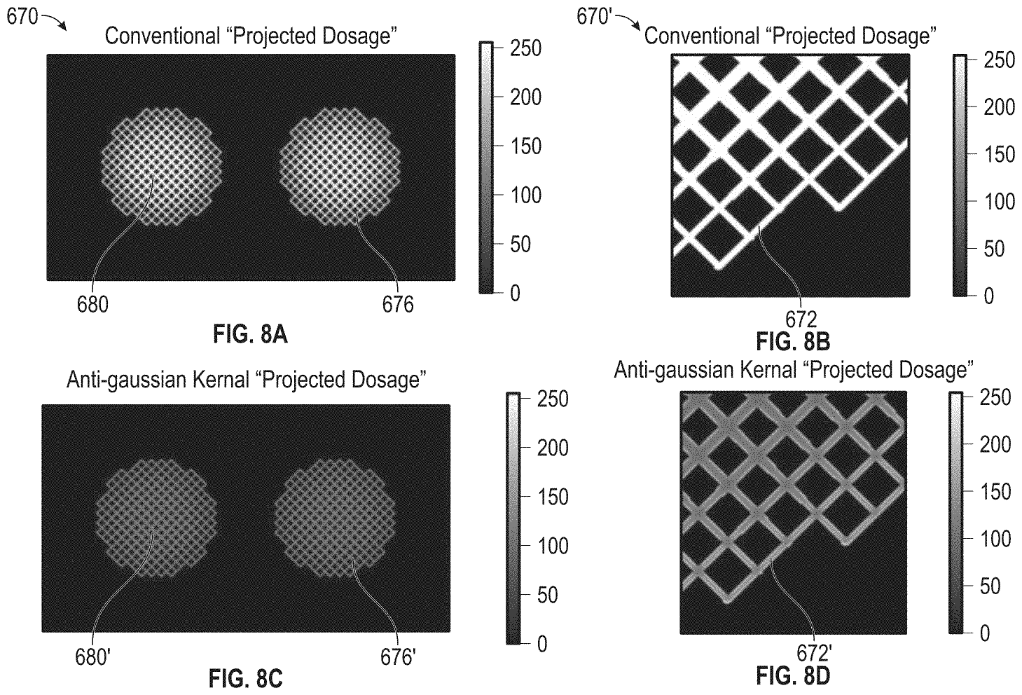

Management of “projected dosages” and “desired dosages” when trying to produce an object that is designed to have specific parameters, features, shapes, and/or configurations can be difficult as a balance is struck between over-curing or under-curing various small and large features of the object being printed. For example, a GRIN lens may have particular small and large features that can be difficult to dose properly across a volume of the lens. More particularly, in brief, GRIN lenses impact the optical path of a light ray by varying the index of refraction within the lens. The GRIN Devices 450, 550 considered in these examples are parts that have a changing dielectric constant radially across the spherical device, as shown in FIGS. 6A and 6B. FIG. 6A depicts a top perspective view of a GRIN device, while FIG. 6B depicts a cross-section through the core of such a device. A dielectric constant can change across a location and/or volume of the device 550. As shown, a unit cell 551 closer to a periphery of the device 550 can have a dielectric constant value of about 1.26 dk, a unit cell 552 further towards a center of the device 550 can have a dielectric constant value of about 1.59 dk, and a unit cell 553 proximate or at a center of the device 550 can have a dielectric constant value of about 1.92 dk. The changing dielectric constant can be realized using a lattice, triply periodic minimal surface (TPMS), or another repeating unit cell construct, such as a cubic or cuboid unit cell (e.g., an octet unit cell). Additional details about TPMS structures and unit cells for use in GRIN devices is disclosed in U.S. Patent Application Ser. No. 63/174,519, filed on Apr. 13, 2021, and entitled “Systems and Methods for Designing and Manufacturing Radio Frequency Devices,” the content of which is incorporate by reference herein in its entirety. The local density of the lattice construct corresponds with a resultant effective dielectric constant-higher density regions result in higher effective dielectric constants, while lower density regions result in lower effective dielectric constants.

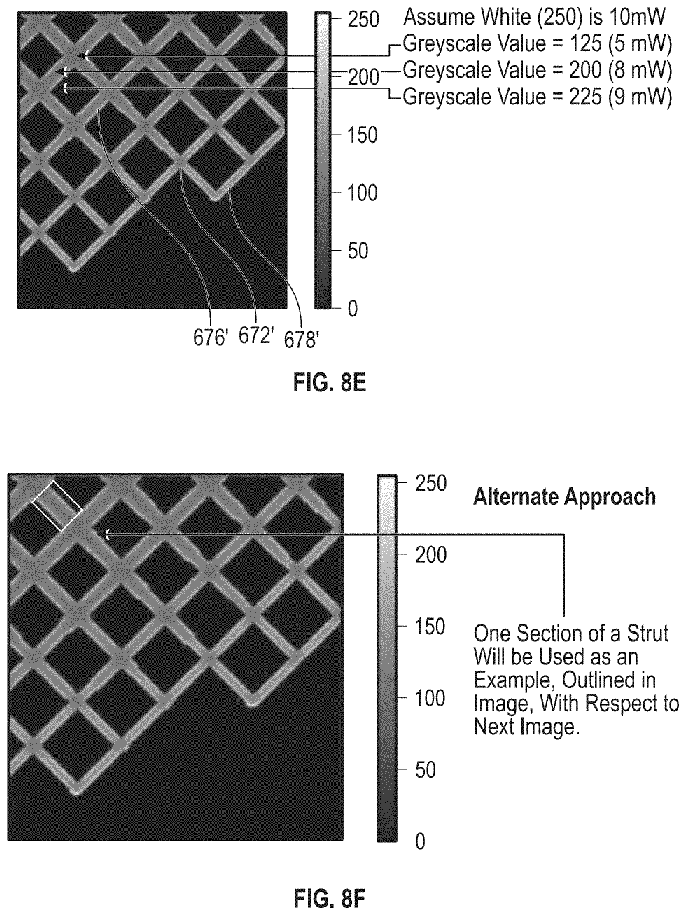

FIGS. 7A-7C depicts failed attempts to print GRIN Lens devices 450, 550, resulting from the impacts of scatter. FIG. 7A depicts a result of a lower projected dosage used to produce the GRIN device 450, which effectively delivered a desired dosage to the larger and more dense feature found at a core 480 of the lens 450. As a result, smaller features 456 around the outside of the lens 450 (which could alternatively be referred to as edges, as in other embodiments disclosed herein) did not resolve. Scatter effectively reduced the received dosage in these smaller features 456 resulting in insufficient curing of the smaller features 456. However, penetration of a needle (not shown) through denser, targeted core region of the lens demonstrated that a lower overall dosage leaves the core 480 of the lens free of over-cure and clogging.

In FIG. 7B, a higher projected dosage was used to deliver the desired dosage to smaller features 556 found at a perimeter of the RF GRIN lens 550. In this case, the outside struts 556 resolved correctly, but larger features (difficult to label, so not labeled) near a denser core 580 of the lens 550 had a received dosage greater than the desired dosage, resulting in the core 580 being over-cured. The core features were accordingly produced with larger than nominal geometries, altering the performance characteristics of the lens 550 and even resulting in a full clogging or polymerization of the core 580. As demonstrated by this example, feature size and proximity can lead to scatter effects that create the conditions for over-curing. FIG. 7C shows needles 590 being inserted at different planes through the lens 550 with higher projected and received dosages that favor the smaller features at an edge 554. However, the needle 590 further in the lens 550 cannot pass through the lens 550 due to clogging of the core 580.

The present disclosures address the aforementioned deficiencies of current methodologies used in DLP additive manufacturing. More particularly, the systems and methods provided apply a transform on the input image that can compensate for the physical scattering of light, resulting in a better approximation to the desired dose and hence to the desired geometry. Several different approaches for this digital filter methodology (e.g., projected image transformations) have been reduced to practice, including, but not limited to, using anti-gaussian kernels, modified Sorbel kernels, unsharp masking kernels, and many other possibilities not necessarily limited to kernels, such as an iterative approach or a machine-learning-based approach. According to at least some embodiments of the systems and methods disclosed herein, an iterative approach for addressing printing scatter can include the steps of (1) making an educated determination or guess about what the transformed image should be to offset the detrimental effects due to scatter; (2) projecting that transformed imaged during a print and/or a simulation of a print; (3) characterizing the outcome of the print and/or the simulation of the print; and then (4) iterating back to (1) with a more educated determination or guess and continuing through this iterative process until a satisfactory result is achieved.

According to at least some embodiments of the systems and methods disclosed herein, a machine-learning approach can compare large datasets of transformed images and associated outcomes and make predictions for transformed images that can result in satisfactory printing outcomes. There can be many algorithms for machine-learning, including but not limited to random forest, neural networks, and others known to those skilled in the art. By way of further non-limiting example of the scope of digital transformations provided for herein, while the present descriptions related to “kernels” can include calculating the transformation at a pixel by using information about its nearby pixels in a two-dimensional context, i.e., based on each slice, the present disclosure also contemplates the ability to utilize digital transformations in a three-dimensional context. That is, kernels and other digital transformations can be implemented based on nearby pixels in layers above and below the slice.

According to at least some embodiments of the systems and methods disclosed herein, each unique kernel exists as a tool in a toolbox of kernels that can be employed to counter the different possible scattering schema unique to each resin system. In other or the same embodiments, a general feature of these digital transformations, or filters, is that the resultant projected images have brighter edges and effectively deliver higher “projected” dosages to edges and across small features. In at least some of such embodiments, this approach can also be used to “characterize” the scatter characteristics of the resin system in question. Thus, the present disclosure not only provides for the implementation of the digital transformations for printing components, but also allows for the usage of the digital transformations as a diagnostic tool.

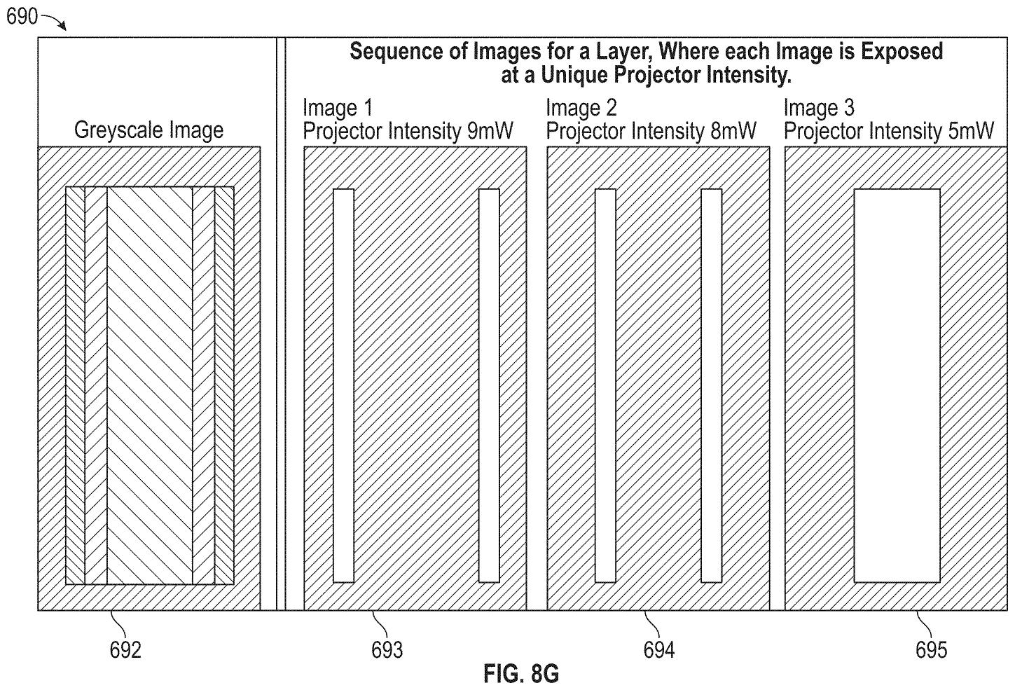

To demonstrate one embodiment of the present disclosure, consider a modified anti-gaussian kernel applied to a projected image. In FIGS. 8A and 8B, a slice 670, 670′ from an RF GRIN Lens is shown. In the illustrated embodiment, a slice 670, 670′ represents a planar image that forms a subset of a 3D model when “sliced” along the Z-axis. While the slices themselves are represented as 2D images formed from sets of pixels, each slice acquires a depth through the additive manufacturing process, such that the 2D pixels ultimately correspond to their 3D voxel counterparts. FIG. 8A and magnified subset FIG. 8B illustrate the projected dosage without an error correction kernel applied, while FIG. 8C and magnified subset FIG. 8D illustrate the projected dosage with an anti-gaussian kernel applied to correct for differences between the delivered dosage and the desired dosage due to scattering. In the conventional projection of FIGS. 8A and 8B, both larger features near a core 680, as well as smaller features 676 near the perimeter of the slice 670′, receive the same projected dosage. Due to scattering, the conventional projected dosage will result in a dosage bias toward the core 680 that can result in a less-than-desirable printed outcome for smaller features 676 of the lens.

In FIG. 8C and magnified subset FIG. 8D, the projected dosage is modified by an anti-gaussian Kernel according to at least one embodiment of the present disclosure, illustrating the various greyscale values that result from using the anti-gaussian Kernel. In the illustrated embodiment, for each greyscale value of a projected intensity, an intensity value can be achieved that is some proportional fraction of 10 mW, which can be the intensity provided by the projector. The intensity change can be controlled on a per-pixel basis within a single greyscale image for each layer of the build, thus allowing for control on a per-voxel basis as the part is being manufactured. FIG. 8E depicts a further magnified example of the magnification of FIG. 8D, showing greater detail regarding grey shifting of pixels according to embodiments of some kernels. The modification of the projected dosage results in a delivered dosage that is closer to the desired dosage at edges 672′ of the lattice and in other small features 676′, while maintaining a desired dosage at a denser core 680′ of the lens. A visualization of the kernel of this embodiment is shown by the highlighting of the edges 672′ of these lattices, which increases radially toward the smaller struts 678 at the periphery. Applying this filtering to the projected images results in the ability to deliver near-nominal received dosage to edges, small features, and large features simultaneously.

FIG. 8F illustrates an alternative approach according to at least one embodiment for controlling pixel intensity on a per-layer basis. In other or the same embodiments, greyscaling images are not utilized. In the embodiment of FIG. 8F, the methodology relies on, for example, controlling the intensity of an LED in a projector (not shown). More particularly, the projector can be configured to shine a series of images for a single layer, where each image is projected at a different intensity.

Further details about how a series of images can be shone is provided for in conjunction with FIG. 8G, which illustrates a sequence of images 690 used to produce a single layer of a printed part. The image 692 on the left side represents the entire greyscale image that is intended to be produced for that layer, while the three images 693, 694, and 695 on the right represent the three projections that will be used to form the image on the left 692. The combination of those three images 693, 694, 695, based on the amount of light provided at the particular locations, will result in the layer being printed in accordance with the image on the left 692. According to at least some embodiments, the images in a sequence can differ in exposure times. For instance, according to at least one embodiment, image 693 can have a higher exposure time than image 694, which, in addition to the variance in projector intensity, creates further variance in projected dosage and received dosage.

In at least some embodiments, the modifications to, or transformations of, each 2D-image for each layer is made prior to printing the layer. In other or the same embodiments, the modifications to the 2D-images can be done in real-time, or near real-time, to allow for the filtering to be done while printing the part. In at least some of such embodiments, this can allow for utilization of feedback control, such as monitoring the print job and adjusting the modifications to the 2D-images to account for the way the part is being printed in real-time.

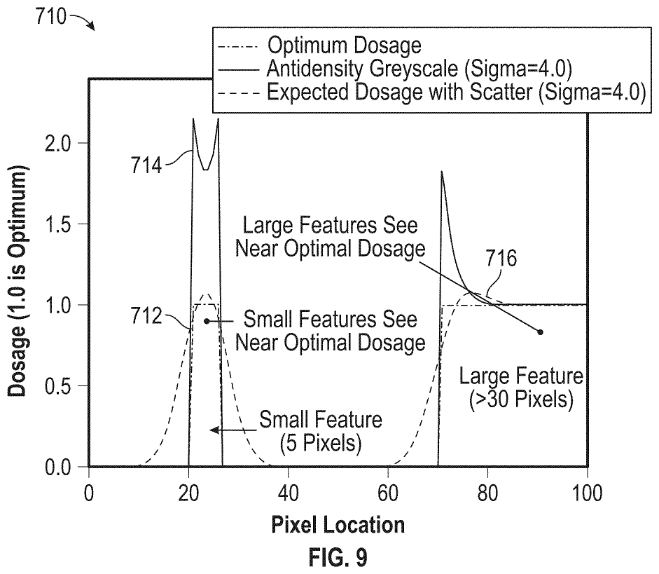

FIG. 9 additionally illustrates the usage of digital transformations, or filters, through a line chart 710. In this chart 710, a dotted line 712 is the desired dosage that the user wants to deliver to the features to be printed. In the embodiment illustrated in FIG. 9, the filtering methodology changes a projected dosage from a profile that normally resembles the dotted line 712 to one that resembles the lighter of the two solid lines 714, 716, (the lines that include dosages at about 2.0 for both the small and large features), exhibiting higher dosages near edges and across smaller features. Accordingly, in such embodiments, a given voxel will receive a projected dosage that is inversely proportional to the desired dosage of the surrounding voxels according to an antidensity principle. Voxels at the edge of a part or in a smaller feature, which are nearby voxels that have a desired dosage of 0, are targeted with a projected dosage that is a greater dosage than the desired dosage. Voxels near the center or that make up the bulk of larger features are target with a projected dosage that is less than or equal to the desired dosage. This antidensity and inverse proportionality carries across several embodiments of this disclosure. In such embodiments, the delivered dosage within the resin closely matches the desired dosage in this case. This methodology allows for edges, small features, and large features to receive close-to desired dosage simultaneously despite the natural scatter of light in many photoresins.

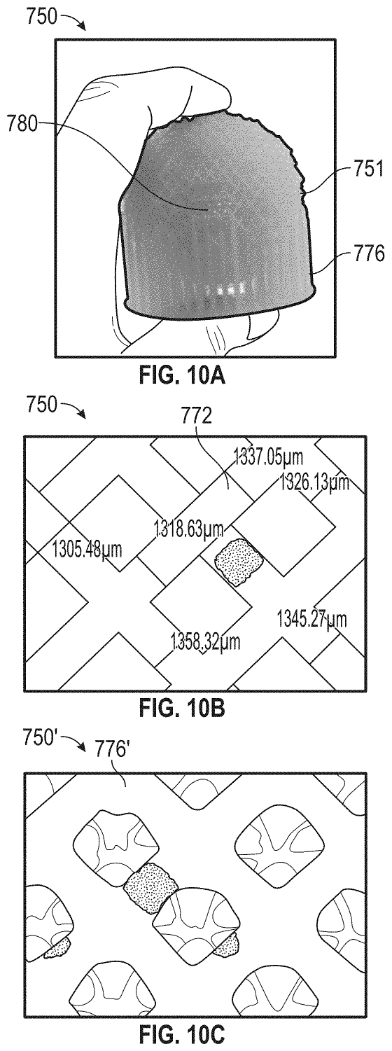

According to other or the same embodiments, the approach of any of FIGS. 8A-9 can be utilized to print RF GRIN lenses, such as a lens 750 shown in FIG. 10A. FIG. 10A showcases an RF GRIN lens 750 for which the projected dosage is modified by an anti-gaussian kernel, thus allowing smaller struts 776 at a periphery 751 of the lens 750 to resolve concurrently with the thicker, denser struts 776 at a core 780. This is evidenced by light easily penetrating the lens 750 (i.e., the core can be seen through as shown), which does not occur with an overexposed core in lenses printed without this filtering approach (see, e.g., FIG. 7C). FIG. 10B showcases a near-nominal structure of the printed RF Grin Lens 750 of this embodiment, including crisp edges 772. For a point of comparison, the structure of a printed RF Grin Lens 750″ without an anti-gaussian kernel applied is shown in FIG. 10C. Here, the intersections of lattice struts 776′ show significant over-cure that can result in poor device performance and clogging of the lattice with semi-cured resin and non-distinct edges 772′. By contrast, the anti-gaussian kernel embodiment of FIG. 10B reduces over-cure, XY scatter, and undesirable deviations in strut geometry.

In other or the same embodiments, a nominal dosage for large features can be delivered throughout a print with a standard projected image and then an additional, edge-highlighted image can be applied separately (after or before). In at least some of such embodiments this can ensure that nominal dosage can be delivered to edges and/or small features.

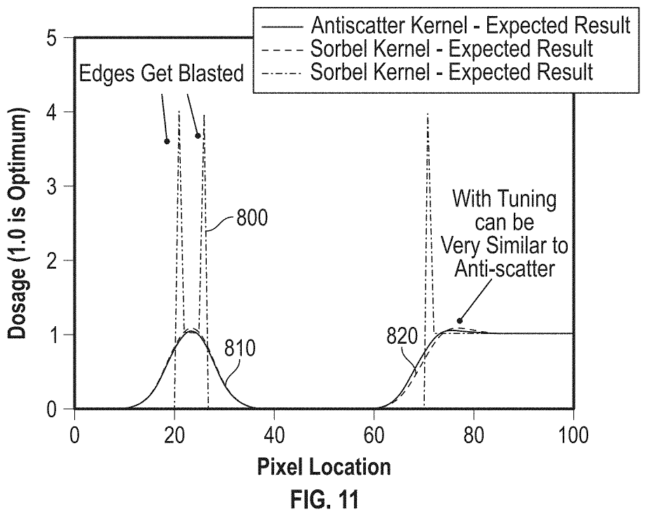

According to other embodiments, a non-limiting example of a digital transformation that can be effectively applied is an edge detection kernel that can highlight edges of projected images, such as a modified Sorbel kernel. In such embodiments, by increasing the projected dosage at the edges of all projected features, a similar effect to the above anti-gaussian kernel can be realized. The line chart in FIG. 11 shows a modified Sorbel kernel applied to the projected dosage in the dotted line 800. The outcome of the received dosage in such an embodiment is shown with a first solid line 810 and is found to closely match the received dosage illustrated by the second solid line 820 (slightly darker than the first solid line) using the above-mentioned anti-gaussian kernel (labeled here as “antiscatter kernel”). In at least some of such embodiments, the first solid line 810 can illustrate a slightly higher dosage amount than the second solid line 820 approximately in the range of about 60 pixel locations and 75 pixel locations.

In some embodiments utilizing a modified Sorbel kernel, a modified Sorbel kernel may offer advantages over an anti-gaussian kernel. In at least some of such embodiments, Sorbel kernels can require fewer parameters that must be determined for successful printing outcomes. Additionally, the processing time of the modified Sorbel kernel that relies on a smaller kernel size can be faster than an anti-gaussian kernel.

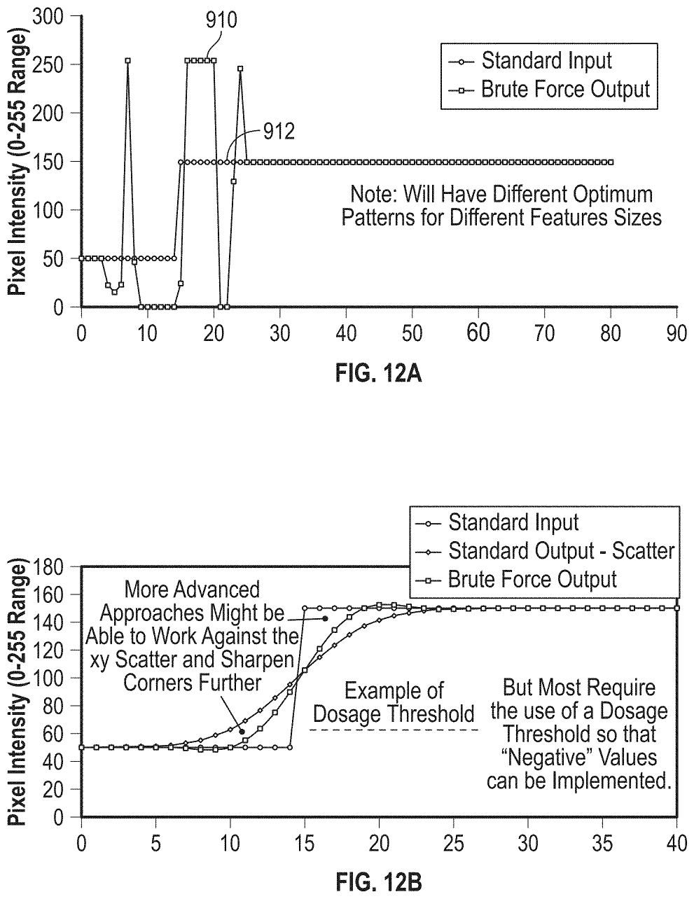

In some embodiments, digital transformations in addition to kernels can be performed to further minimize x-y scatter. FIGS. 12A and 12B show an iterative approach according to some embodiments for optimizing the received dosage to an edge by first figuring out the best-fit intensities for the “projected” dosages in all nearby pixels. In this non-limiting example, a brute-force projected dosage 910 is shown in contrast to a standard input 912, but the outcome of the received dosage 920 can be closer to the desired dosage 930. Less x-y scatter can be realized with such approaches. At least some embodiments of these approaches can leverage the existence of a dosage threshold below which no photoresin curing occurs. This can effectively allow for “negative” dosage that can provide additional resolution in addressing x-y scatter.

According to at least some embodiments, the use of machine learning can be implemented to best predict a projected dosage that can result in a received dosage that most closely represents the desired dosage.

At least some embodiments utilize many different types of digital transformations, or filters, beyond the few mentioned here that might effectively deliver a higher “projected” dosage to the edges and small features as compared to larger features. The digital transformations provided for herein typically result in a highlighting of the edges throughout a projected geometry. These associated greyscale images are importantly opposite of recent “grey-scaling” disclosures, patents, patent applications, and products released by competitive companies that use grey-scaling and anti-aliasing to blur out edges of printed parts to achieve “higher resolution.” To the contrary, the present disclosures operate in an opposite fashion, hitting edges with higher dosages (not lower dosages) to actively combat scatter.

The decision as to how much intensity to provide to a given pixel can be based, at least in part, on surrounding, or nearby, pixels. More particularly, the transformations or convolutions provided for by the filters can involve a single pass or multiple passes. For example, a transformed image can be transformed again with the same or a different transformation process. Additionally, information from the previous and next layers can be used to influence the transformation on the current image.

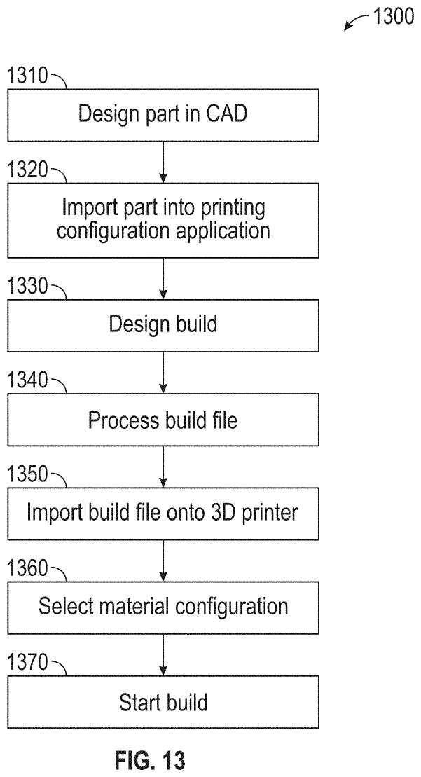

FIG. 13 depicts a simplified representation of a known process of 3D printing without applying a digital transformation as provided for herein (e.g., projected image transformations, including kernels), to projected image files in DLP printing to combat the detrimental effects of scatter that occurs in many photopolymer resins. In this known build design workflow 1300, a part can be designed in CAD, or other suitable design software, at step or action 1310 (a person skilled in the art will appreciate the terms step and action may be used interchangeably herein in most instances), and imported into a printing configuration application at step 1320. According to at least some embodiments, the printing configuration application can be a software platform such as “Fortify Compass,” which is available through 3DFortify Inc. of Boston, Mass., although a person skilled in the art will appreciate many different software platforms on which the present flowcharts and related disclosures can be implemented. The build can then be designed at step 1330, for example by selecting desired parameters and geometries, positions of the part to be printed, rotation of the part to be printed, configurations and applications of support structures upon which the part to be printed are built, etc. to be used in conjunction with the designed part that was imported at step 1320. After completion of the design build at step 1330, a build file can be created and/or processed at step 1340, setting up a file that can be used by a 3D printer. Actions associated with processing the build file include, but are not limited to, generating slice images and/or generating instructions for driving an additive manufacturing device (this can come in the form, for example, of computer code or other software), among other features. These actions can be performed on a software platform like “Fortify Compass” or other platforms. As discussed herein, a variety of types of 3D printing (e.g., SLA, DLP, LCD, among others) and 3D printers can be utilized, and the build file can be built and processed in a manner suitable for the type of 3D printing being performed and/or the printer being used. The designing and processing steps 1330, 1340 can be performed iteratively such that step 1330 does not necessarily have to be complete for step 1340 to occur and/or the steps can be performed multiple times. In at least some embodiments, multiple build files can be built, although often times the build file is a single file.

The processed file(s) can be imported into a 3D printer at step 1350. This may involve exporting the build file from the software platform (e.g., Fortify Compass). The format of the file can depend, at least in part, on the type of printing being performed, the underlying processor and/or software associated with the printer, and other factors appreciated by those skilled in the art. Another aspect of the process can include selecting material(s) and/or a material configuration, as indicated at step 1360. This can include selecting one or more materials based on information in the build file and/or preferences of the user, among other factors. Material configuration includes the type of material(s) being used, as well as various properties and/or parameters of the material (e.g., viscosity, hardness, etc.). Once the build file is loaded, materials selected, and any other parameters or preferences have been set, inputted, etc., the build can be initiated, as shown at step 1370.

According to at least some embodiments, parameters for a build file can include UV cure parameters. According to at least some embodiments, these UV cure parameters can be approximately in the range of about 0 mJ/cm\hat{ }2 to about 1000 mJ/cm\hat{ }2. According to at least some embodiments, the projected dose can vary approximately in the range of about 0 mJ/cm\hat{ }2 to about 10,000 mJ/cm\hat{ }2. In other or the same embodiments, UV cure parameters can include a projected intensity varying approximately in the range of about 0 30 mW/cm\hat{ }2 to about 30 mW/cm\hat{ }2. In other or the same embodiments, this projected intensity can vary approximately in the range of about 0 W/cm\hat{ }2 to about 300 m W/cm\hat{ }2.

In previously known techniques, digital masks were used to fight the detrimental effects of intensity variations across a projector in a DLP printing process. Scatter, however, was a primarily unaddressed problem prior to the present disclosures. Notably, applying the digital transformations of the present disclosure to fight the detrimental effects of scatter can be implemented in conjunction (either before or after) applying digital masks to fight the detrimental effects of intensity variations across the projector.

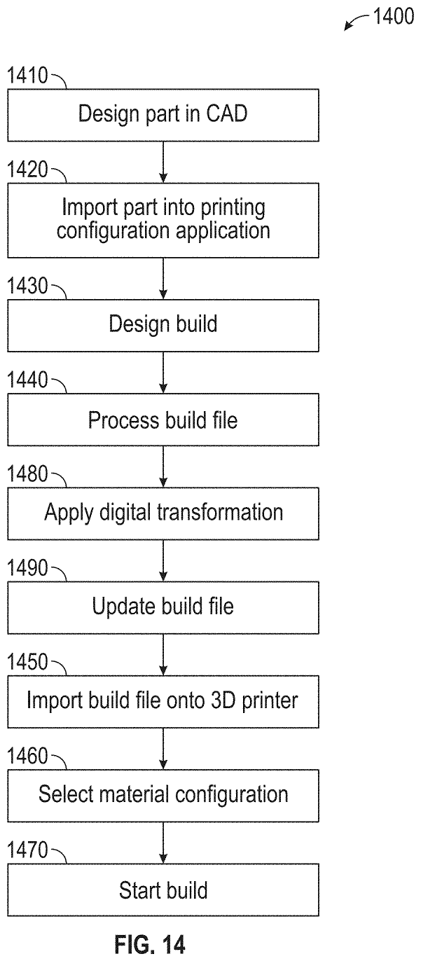

FIG. 14 shows a build design workflow 1400 that represents a simplified representation of a process of 3D printing that includes applying a digital transformation in accordance with the present disclosures (e.g., projected image transformations-including kernels) to projected image files in additive manufacturing printing to fight the detrimental effects of scatter that occurs in many photopolymer resins. In the workflow of FIG. 14, similar to the workflow 1300, a part can be designed in CAD at step 1410, and the resulting design file can be imported into the printing configuration application at step 1420. The build can subsequently be designed at step 1430 and the build file can be processed at step 1440. Each of steps 1410, 1420, 1430, and 1440 can be performed similarly to the steps 1310, 1320, 1330, and 1340 described above and/or performed in manners known to those skilled in the art. The workflow 1400 diverges from the workflow 1300 starting at step 1480, where a digital transformation is applied, and step 1490, where a build file is updated in view of the digital transformation. One or more digital transformations, such as those described herein, can be applied at step 1480. According to at least some embodiments, step 1480 can further include actions such as evaluating slice images, establishing appropriate filter(s) (e.g., kernel input values), and/or applying filter(s) and re-processing the slice images that were generated as part of the build file. For DLP printing, for example, the digital transformation(s) can provide an adjusted light intensity at one or more designated pixels of an image projected by the digital light projector, which in turn results in a more accurate and desirable build. At step 1490, the build file can then be updated according to these transformations at step 1480. This can include, for example, removing one or more binary images from the build file and replacing those image(s) with one or more filter-adjusted image(s). Similar to steps 1330 and 1340, and thus steps 1430 and 1440, steps 1480 and 1490 can be performed iteratively such that step 1480 does not necessarily have to be completed (i.e., not all digital transformations have to be completed to update the build file) for step 1490 to occur and/or the steps can be performed multiple times. Additional digital transformations can be performed after one or more have already been performed to improve the build file, and thus the resulting build. The build file(s) can be imported at step 1450, materials selected at step 1460, and the build started at step 1470. The actions of steps 1450, 1460, and 1470 can be performed in a similar way as described above with respect to steps 1350, 1360, and 1370, although the build file, material configuration, and build are now informed by the digital transformation(s) applied at step 1480, thus resulting in a the more accurate and desirable build. For example, adjusting material configuration parameters at step 1460 can occur to accommodate image modifications resulting from the application of the digital transformation(s).

Further elaborating on the step 1480, in at least some embodiments, once sliced images have been created, a digital tool can be used to evaluate the stack of slice images to establish the appropriate input parameter(s) for the digital transformation application. Once the parameter(s) has been established, the images can be reprocessed by the digital tool from the original binary image to a grey-scaled image. The user can edit the build file, for example by removing the stack of binary images and replacing it with the greyscale images. Modifications can be made to the material configuration file to accommodate for the lower-intensity greyscale images. Other ways of performing digital transformations are also possible, as informed by the disclosures above and the knowledge of those skilled in the art in view of the present disclosures.

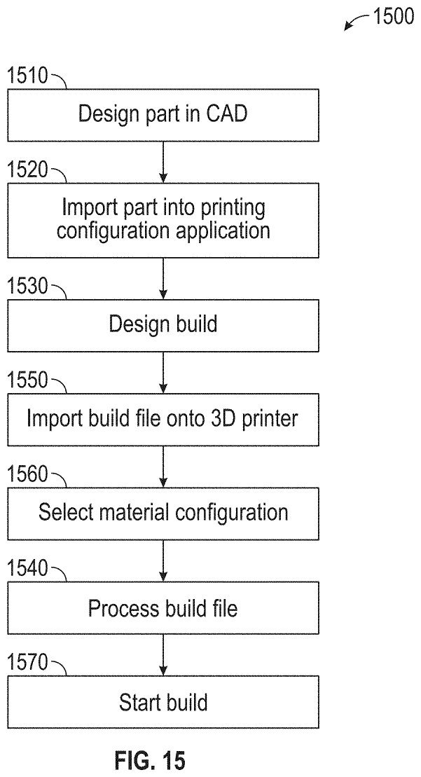

In an alternative implementation of the workflow 1400 of FIG. 14 shown in FIG. 15, a workflow 1500 can incorporate the application of the digital transformations to fight detrimental effects of scatter directly into the printing configuration application, and the build file can be completed without the need for user intervention. Similar to the workflows 1300 and 1400, workflow 1500 depicts a part designed in CAD at step 1510 imported into a printing configuration application at step 1520, and the build can be designed at step 1530. Unlike the workflows 1300 and 1400 though, the workflow 1500 does not include a processing of the build file action prior to importing the build file onto a 3D printer. Instead, as shown, the file generated by the design build action at step 1530 is imported onto a 3D printer at step 1550. The material configuration action of step 1560 can subsequently be performed in view, at least in part, on the imported build file and/or user preferences, similar to the step 1460. Further, a processing of the build file step, step 1540, can be performed at the level of the 3D printer. The actions performed in conjunction with step 1540 can include the actions described above with respect to steps 1340 and 1440, including the generation of slice images and/or instructions (e.g., code, software, computer product, etc.) for deriving an additive manufacturing device and the application of digital filter(s) to fight detrimental effects of scatter. As shown that action occurs after selecting material configuration, although in other embodiments it can occur before, simultaneously, and/or in conjunction with the material configuration selection step 1560. The processing of the build step 1540 can occur in manners disclosed herein or otherwise known to those skilled in the art in view of the present disclosures. The build can then be initiated at step 1570. In such embodiments, part of the material configuration step 1560 can include determining or otherwise factoring in the digital transformation parameters required to apply the digital transformations for scatter. The software can apply the transformation of the slice images at the printer. In at least some exemplary embodiments of the system, the user can select the material that he or she wants to print at the printer. The same build file can be used for different materials. The binary images that come from the slicing process can be transformed using parameters that can be optimized for the selected material.

According to at least some embodiments, several different approaches for a digital transformation methodology use anti-gaussian kernels, modified Sorbel kernels, unsharp masking kernels, and many other possibilities (e.g., the application of kernels in a three-dimensional context), and such embodiments are not necessarily limited to kernels, such as an iterative approach or a machine-learning-based approach. Each unique kernel, or other transformation(s)/filter(s), can exist as a tool in a toolbox of kernels, or other transformations/filters, that can be employed, for example, to counter the different possible scattering schema unique to each resin system. In at least some embodiments, a feature of these transformations/filters can be that the resultant projected images have brighter edges and effectively deliver higher “projected” dosages to edges and across small features. This approach can also be used to “characterize” the scatter characteristics of the resin system in question.

The present disclosure introduces not only the implementation of digital transformations for printing components, but also the usage of the digital transformation as a diagnostic tool according to at least some embodiments. One or more digital transformations can be used to show how well various resins cure with respect to the digital transformation being used and the amount of light exposure. By examining these prints, various diagnostic information regarding the behavior of scattering in a particular print medium can be determined. In some instances, the diagnostics can be done in real-time, or near real-time, to allow for adjustments to the print job to be made in response to the same using some combination of controllers and/or sensors in a feedback loop(s). By analyzing how the digital transformations disclosed herein are impact the resulting prints, one can effectively model how scattering impacts a printing medium.

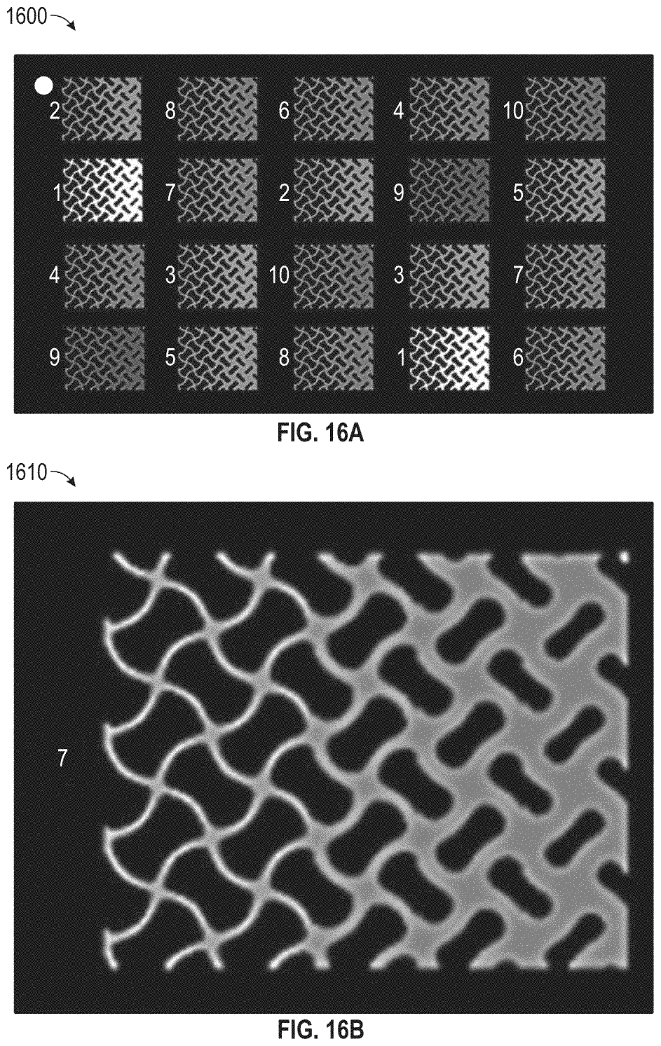

One non-limiting embodiment of applying the presently disclosed principles to a diagnostic tool is illustrated in FIGS. 16A and 16B. The embodiment of FIG. 16A depicts a gyroid working curve build set 1600. To generate build set 1600, each of images can begin with the same untransformed initial image, with the untransformed initial image being of a gyroid working curve designed to display several large, small, and/or edge features within the confines of a printed part. Each untransformed initial image can then be transformed by a different digital transformation, such that the projected dosage profile for each of images is a variation of the untransformed original image. The resulting printed parts are then inspected to determine which of images printed with the greatest accuracy, or which of the images received closest to the desired dosage at each voxel.

FIG. 16B depicts a magnified schematic of image 1610. The intended geometry of each part can be identical or unique, and contain geometries that reflect the challenging geometries described in previous sections (e.g., edges and/or smaller features printed concurrently with dense features). Within a diagnostic build, a variety of digital transformation types and digital transformation configurations can be applied across the array of parts, where each part experiences a unique transformation. FIGS. 16A-16B demonstrate one non-limiting example of how multiple unique filter configurations can be applied to a single build design as a tool to “characterize” the photopolymer scatter behavior. Once printed, observation and/or measurement of the geometry for each part in the array can provide insights into the scatter behavior of the photopolymer system.

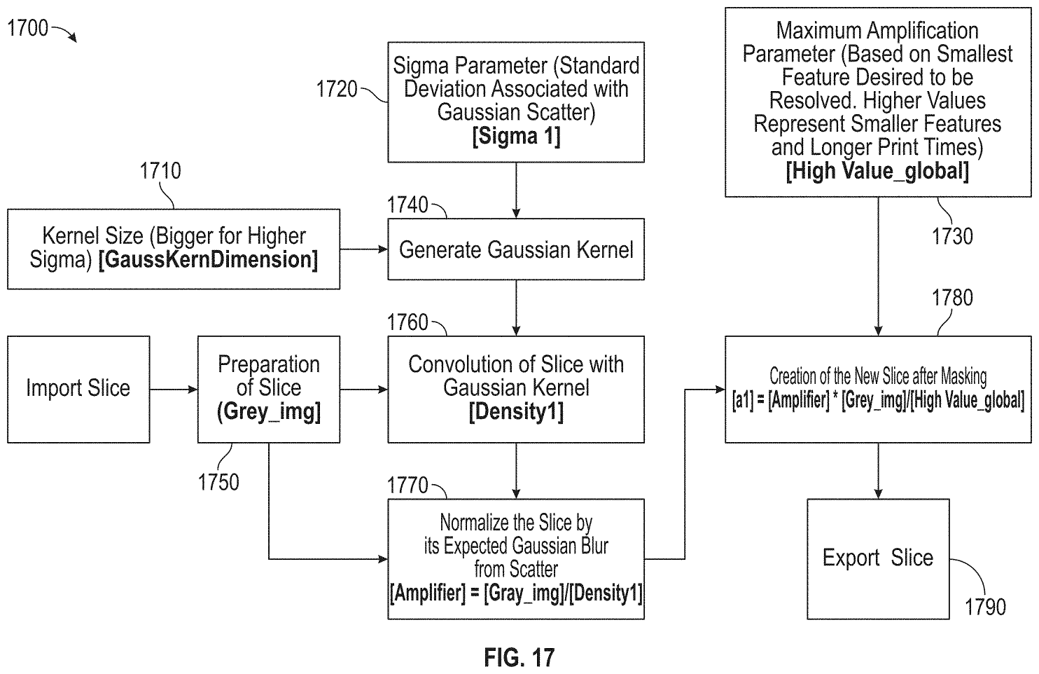

In one embodiment, an anti-gaussian kernel can be implemented, and according to some of such embodiments the kernel can reflect a deconvolution such as a Richardson Lucy deconvolution. One non-limiting implementation framework 1700 for the anti-gaussian kernel variety of digital transformation is shown in FIG. 17. In this flowchart, the bolded, bracketed terms represent internal variables in Python code for reference, such terms being provided for convenience. It is understood that these variables, and the engine of their implementation, will vary, at least in part, based on the embodiment of the printing configuration application and/or the printer on which these the systems and methods disclosed herein are implemented.

In the embodiment of FIG. 17, there are three main user parameters including the kernel size 1710, sigma parameter 1720, and maximum amplification parameter 1730, although a person skilled in the art, in view of the present disclosures, will understand other possible parameters that can be used in addition to, or in lieu of, one or more of these three main user parameters. The kernel size 1710 can be calculated directly from the sigma parameter 1720 in some embodiments so a user input is not required. Larger sigma parameters 1720 can require larger kernel sizes 1710 to avoid losing digital information. The sigma parameter 1720 of the illustrated embodiment can essentially be the standard deviation associated with the gaussian scatter process of the employed material and the employed printer configurations. This sigma parameter 1720 can therefore be an important value to characterize. Tuning of the sigma parameter 1720 during a printing process can be used, for example, to back-calculate and/or characterize the scatter of a material. The maximum amplification factor 1730 can be a tunable value for the user in at least some embodiments, and in at least some of such embodiments this value is at most the highest single amplifier value across all of the imported slices for a print. In at least some of such embodiments, using lower values than this highest value can increase overall print time by increasing the overall intensity of the exported slice, but can cause the smallest features or edges to not be properly resolved. In such embodiments, these parameters are seen as a user input required to balance printer performance with part outcomes.

In framework 1700, sigma parameter 1720 and kernel size 1710 can be used to generate a gaussian kernel(s) 1740. Coupled with the preparation of a slice at action 1750, the slice can be convoluted with the gaussian kernel at action 1760, which can be normalized at action 1770. This normalized slice can then be combined with the maximum amplification parameter 1730 at action 1780.

According to at least some embodiments, the transformation can be implemented using image convolution, an alternative image processing technique. Implementation of the present disclosures on a computer readable medium can include a central processing unit (CPU), memory, and/or support circuits (or 1/O), among other features. In embodiments having a memory, that memory can be connected to the CPU, and may be one or more of a readily available memory, such as a read-only memory (ROM), a random access memory (RAM), floppy disk, hard disk, cloud-based storage, or any other form of digital storage, local or remote. Software instructions, algorithms, and data can be coded and stored within the memory for instructing the CPU. Support circuits can also be connected to the CPU for supporting the processor in a conventional manner. The support circuits may include conventional cache, power supplies, clock circuits, input/output circuitry, and/or subsystems, and the like. Output circuitry can include circuitry allowing the processor to control a magnetic field generator, light source, and/or other components of an additive photopolymerization printer. In some embodiments, a user can selectively employ the methods described herein, or otherwise derivable from the present disclosure, within image slices produced in the computer readable medium. Convolution can be performed efficiently, but it can be further optimized by leveraging the graphics processing unit (GPU).

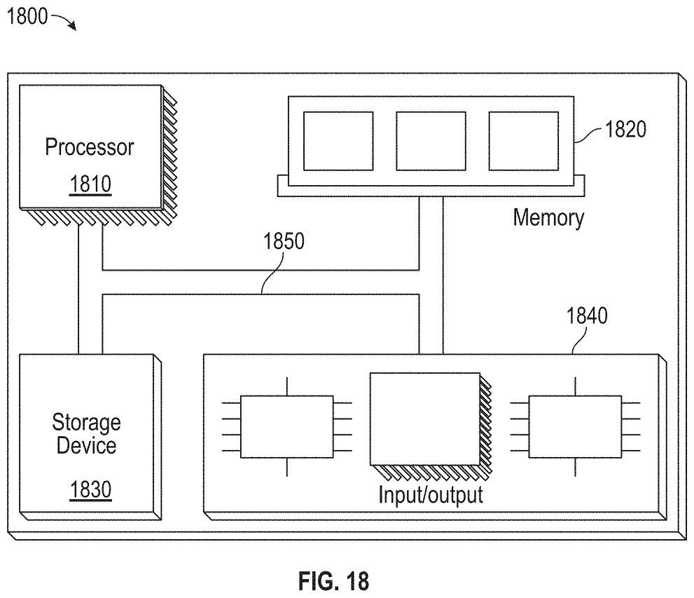

FIG. 18 provides for one non-limiting example of a computer system 1800 upon which actions, provided for in the present disclosure, including but not limited to instructions for driving an additive manufacturing device, can be built, performed, trained, etc. The system 1800 can include a processor 1810, a memory 1820, a storage device 1830, and an input/output device 1840. Each of the components 1810, 1820, 1830, and 1840 can be interconnected, for example, using a system bus 1850. The processor 1810 can be capable of processing instructions for execution within the system 1800. The processor 1810 can be a single-threaded processor, a multi-threaded processor, or similar device. The processor 1810 can be capable of processing instructions stored in the memory 1820 or on the storage device 1830. The processor 1810 may execute operations such as generating build instructions and/or applying antidensity transformations, among other features described in conjunction with the present disclosure.

The memory 1820 can store information within the system 1800. In some implementations, the memory 1820 can be a computer-readable medium. The memory 1820 can, for example, be a volatile memory unit or a non-volatile memory unit. In some implementations, the memory 1820 can store information related to the instructions for manufacturing sensing arrays, among other information.

The storage device 1830 can be capable of providing mass storage for the system 1800. In some implementations, the storage device 1830 can be a non-transitory computer-readable medium. The storage device 1830 can include, for example, a hard disk device, an optical disk device, a solid-date drive, a flash drive, magnetic tape, or some other large capacity storage device. The storage device 1830 may alternatively be a cloud storage device, e.g., a logical storage device including multiple physical storage devices distributed on a network and accessed using a network. In some implementations, the information stored on the memory 1820 can also or instead be stored on the storage device 1830.

The input/output device 1840 can provide input/output operations for the system 1800. In some implementations, the input/output device 1840 can include one or more of network interface devices (e.g., an Ethernet card), a serial communication device (e.g., an RS-232 10 port), and/or a wireless interface device (e.g., a short-range wireless communication device, an 802.11 card, a 3G wireless modem, a 4G wireless modem, or a 5G wireless modem). In some implementations, the input/output device 1840 can include driver devices configured to receive input data and send output data to other input/output devices, e.g., a keyboard, a printer, and display devices (such as the GUI 12). In some implementations, mobile computing devices, mobile communication devices, and other devices can be used.

In some implementations, the system 1800 can be a microcontroller. A microcontroller is a device that contains multiple elements of a computer system in a single electronics package. For example, the single electronics package could contain the processor 1810, the memory 1820, the storage device 1830, and input/output devices 1840.

The present disclosure also accounts for providing a non-transient computer readable medium capable of storing instructions. The instructions, when executed by a computer system like the system 1800, can cause the system 1800 to perform the various functions and methods described herein for printing, forming build files, etc.

Some non-limiting examples of the above-described embodiments can include the following:

1. An additive manufacturing device comprising:

a tank configured to have a photopolymer resin material disposed therein;

a build plate disposed above the tank and configured to at least move along a vertical axis, away from the tank;

a light projector configured to project an image of a part to be printed towards the tank; and

a processor, configured to:
apply one or more digital transformations to a build file to provide an adjusted light intensity for a projected dosage at one or more designated pixels of the image projected by the digital light projector, the adjusted light intensity being based on an untransformed initial image prior to application of the one or more digital transformations to one or more nearby pixels of the one or more designated pixels, the projected dosage for the one or more designated pixels being inversely proportional to the untransformed initial image intensity for the one or more nearby pixels.
   2. The additive manufacturing device of claim 1, wherein the build file comprises a plurality of slice images that comprise the image of the part to be printed, and wherein the processor is further configured to:

remove at least one of one or more binary images or one or more greyscale images from the build file; and

replace at least one of the at least one removed binary image or one removed greyscale image with an at least one transformed slice image of the plurality of slice images.

3. The additive manufacturing device of claim 1 or claim 2, wherein the processor is further configured to:

generate a plurality of slice images that comprise the image of the part to be printed;

generate instructions for driving the additive manufacturing device for the part to be included as part of the build file; and

apply the one or more digital transformations to at least one slice image of the plurality of slice images.

4. The additive manufacturing device of any of claims 1 to 3, wherein applying one or more digital transformations to a build file to adjust a light intensity further comprises amplifying light intensity at the one or more designated pixels.
5. The additive manufacturing device of any of claims 1 to 4, wherein the one or more designated pixels comprise one or more pixels located at at least one of a geometric edge of the part or a smaller feature of the part.
6. The additive manufacturing device of any of claims 1 to 5, wherein the one or more digital transformations further comprises one or more kernels.
7. The additive manufacturing device of claim 6, wherein the one or more kernels comprise at least one of: an anti-gaussian kernel, a modified Sorbel kernel, or an unsharp masking kernel.
8. The additive manufacturing device of any of claims 1 to 7, wherein applying one or more digital transformations to a build file to adjust a light intensity at one or more designated pixels of the image projected by the digital light projector further comprises utilizing a sequence of images for different exposure times to produce a single layer of the printed part.
9. The additive manufacturing device of any of claims 1 to 8, wherein applying one or more digital transformations to a build file to adjust a light intensity at one or more designated pixels of the image projected by the digital light projector further comprises utilizing a machine-learning based approach that compares large datasets of transformed images and associated outcomes to make predictions for a transformed image of the build file to produce a single layer of the printed part.
10. A method of printing, comprising:

applying one or more digital transformations to a build file to provide an adjusted light intensity for a projected dosage at one or more designated pixels of the image projected by a digital light projector, the adjusted light intensity being based on an untransformed initial image prior to application of the one or more digital transformations to one or more nearby pixels of the one or more designated pixels, the projected dosage for the one or more designated pixels being inversely proportional to the untransformed initial image for the one or more nearby pixels, the build file comprising information about the part to be printed.

11. The method of claim 10, further comprising:

applying the one or more digital transformations to at least one slice image of a plurality of slice images of the build file, the plurality of slice images comprising the image of the part to be printed; and

re-processing the at least one slice image of the plurality of slice images to account for the applied one or more digital transformations.

12. The method of claim 11, wherein re-processing the at least one slice image further comprises:

removing at least one of one or more binary images or one or more greyscale images from the build file; and

replacing at least one of the at least one removed binary image or one removed greyscale image with the at least re-processed slice image in the plurality of slice images.

13. The method of any of claims 10 to 12, further comprising:

processing the build file by at least one of:
generating a plurality of slice images for the part to be included as part of the build file;
generating instructions for driving the additive manufacturing device for the part to be included as part of the build file; or
exporting the processed build file to a controller to operate the DLP printer.
   14. The method of any of claims 10 to 13, wherein the one or more designated pixels comprise one or more pixels located at at least one of a geometric edge of the part or a smaller feature of the part.
   15. The method of any of claims 10 to 14, wherein applying one or more digital transformations to a build file to provide an adjusted light intensity at one or more designated pixels of the image projected by the digital light projector further comprises utilizing a sequence of images for different exposure times to produce a single layer of the printed part.
   16. The method of any of claims 10 to 15, wherein applying one or more digital transformations to a build file to provide an adjusted light intensity at one or more designated pixels of the image projected by the digital light projector further comprises utilizing an iterative approach that updates an educated determination about the light intensity to be used in conjunction with a transformed image of the build file to produce a single layer of the printed part.
   17. A method of printing, comprising:

applying one or more digital transformations to a build file for a part to be printed to adjust a projected dosage of light at one or more designated pixels of an image to be projected in conjunction with printing the part to yield a desired dosage of light at the one or more designated pixels during printing, the desired dosage of light being based on a light intensity of an untransformed initial image intended to be supplied to one or more nearby pixels of the one or more designated pixels, and the desired dosage of light for the one or more designated pixels being inversely proportional to the intended light intensity for the one or more nearby pixels; and

performing digital light processing printing based on the build file to print the part.

18. The method of printing claim 17, wherein applying one or more digital transformations to a build file to provide an adjusted light intensity at one or more designated pixels of the image projected by the digital light projector further comprises utilizing a sequence of images for different exposure times to produce a single layer of the printed part.
19. The method of printing claim 17 or claim 18, wherein applying one or more digital transformations to a build file to provide an adjusted light intensity at one or more designated pixels of the image projected by the digital light projector further comprises utilizing an iterative approach that updates an educated determination about the light intensity to be used in conjunction with a transformed image of the build file to produce a single layer of the printed part.
20. The method of printing any of claims 17 to 20, wherein applying one or more digital transformations to a build file to provide an adjusted light intensity at one or more designated pixels of the image projected by the digital light projector further comprises utilizing a machine-learning based approach that compares large datasets of transformed images and associated outcomes to make predictions for a transformed image of the build file to produce a single layer of the printed part.
21. A diagnostic method, comprising:

applying one or more digital transformations to an image to be projected in conjunction with digital light processing manufacturing; and

assessing one or more parameters associated with resin cure for the digital light processing manufacturing.

22. The diagnostic method of claim 21, wherein the one or more parameters comprise at least one of properties of the resin, an intensity of light exposure, or a duration of light exposure.
23. The diagnostic method of claim 21 or 22, further comprising:

operating a feedback loop to perform the diagnostic method.

24. The diagnostic method of any of claims 21 to 23, wherein the assessing action is performed in one of real-time or near real-time while manufacturing a printed part based on the image and related images.
25. An additive manufacturing device, comprising:

a tank configured to have a photopolymer resin material disposed therein;

a build plate disposed above the tank and configured to at least move along a vertical axis, away from the tank;

a light projector configured to project an image of a part to be printed towards the tank; and

a processor, configured to:
transform the image of the part to be printed by applying one or more filters to the image prior to printing based on the image, the one or more filters adjusting an applied light intensity to one or more designated pixels in an inversely proportional manner with respect to an intended light intensity, the intended light intensity being a light intensity that would be applied in a non-transformed image to one or more nearby pixels of the one or more designated pixels.
   26. The additive manufacturing device, incorporating any of the features recited in any of claims 1 to 9.
   27. A method of printing, comprising:
transforming an image of a part to be printed by applying one or more filters to the image prior to printing based on the image, the one or more filters adjusting an applied light intensity to one or more designated pixels in an inversely proportional manner with respect to an intended light intensity, the intended light intensity being a light intensity that would be applied in a non-transformed image to one or more nearby pixels of the one or more designated pixels.
   28. The method of claim 27, incorporating any of the features recited in any of claims 10 to 20.

One skilled in the art will appreciate further features and advantages of the present disclosure based on the above-described embodiments. Accordingly, the disclosure is not to be limited by what has been particularly shown and described, except as indicated by the appended claims. Further, a person skilled in the art, in view of the present disclosures, will understand how to implement the disclosed systems and methods provided for herein in conjunction with DLP-style additive manufacturing printers. All publications and references cited herein are expressly incorporated herein by reference in their entireties.

In the foregoing detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present disclosure. While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspects of the disclosed concepts to the embodiments illustrated. As will be realized, the subject technology is capable of other and different configurations, several details are capable of modification in various respects, embodiments may be combine, steps in the flow charts may be omitted or performed in a different order, all without departing from the scope of the subject technology. Accordingly, the drawings, flow charts, and detailed description are to be regarded as illustrative in nature and not as restrictive.

What is claimed is:

1. An additive manufacturing device comprising:
a tank configured to have a photopolymer resin material disposed therein;
a build plate disposed above the tank and configured to at least move along a vertical axis, away from the tank;
a light projector configured to project an image of a part to be printed towards the tank; and
a processor, configured to:
apply one or more digital transformations to a build file to provide an adjusted light intensity for a projected dosage at one or more designated pixels of the image projected by the digital light projector, the adjusted light intensity being based on an untransformed initial image prior to application of the one or more digital transformations to one or more nearby pixels of the one or more designated pixels, the projected dosage for the one or more designated pixels being inversely proportional to the untransformed initial image intensity for the one or more nearby pixels.

2. The additive manufacturing device of claim 1, wherein the build file comprises a plurality of slice images that comprise the image of the part to be printed, and wherein the processor is further configured to:
remove at least one of one or more binary images or one or more greyscale images from the build file; and
replace at least one of the at least one removed binary image or one removed greyscale image with an at least one transformed slice image of the plurality of slice images.

3. The additive manufacturing device of claim 1, wherein the processor is further configured to:
generate a plurality of slice images that comprise the image of the part to be printed;
generate instructions for driving the additive manufacturing device for the part to be included as part of the build file; and
apply the one or more digital transformations to at least one slice image of the plurality of slice images.

4. The additive manufacturing device of claim 1, wherein applying one or more digital transformations to a build file to adjust a light intensity further comprises amplifying light intensity at the one or more designated pixels.

5. The additive manufacturing device of claim 1, wherein the one or more designated pixels comprise one or more pixels located at at least one of a geometric edge of the part or a smaller feature of the part.

6. The additive manufacturing device of claim 1, wherein the one or more digital transformations further comprises one or more kernels.

7. The additive manufacturing device of claim 6, wherein the one or more kernels comprise at least one of: an anti-gaussian kernel, a modified Sorbel kernel, or an unsharp masking kernel.

8. The additive manufacturing device of claim 1, wherein applying one or more digital transformations to a build file to adjust a light intensity at one or more designated pixels of the image projected by the digital light projector further comprises utilizing a sequence of images for different exposure times to produce a single layer of the printed part.

9. The additive manufacturing device of claim 1, wherein applying one or more digital transformations to a build file to adjust a light intensity at one or more designated pixels of the image projected by the digital light projector further comprises utilizing a machine-learning based approach that compares large datasets of transformed images and associated outcomes to make predictions for a transformed image of the build file to produce a single layer of the printed part.

10. A method of printing, comprising:
applying one or more digital transformations to a build file to provide an adjusted light intensity for a projected dosage at one or more designated pixels of the image projected by a digital light projector, the adjusted light intensity being based on an untransformed initial image prior to application of the one or more digital transformations to one or more nearby pixels of the one or more designated pixels, the projected dosage for the one or more designated pixels being inversely proportional to the untransformed initial image for the one or more nearby pixels, the build file comprising information about the part to be printed.

11. The method of claim 10, further comprising:
applying the one or more digital transformations to at least one slice image of a plurality of slice images of the build file, the plurality of slice images comprising the image of the part to be printed; and
re-processing the at least one slice image of the plurality of slice images to account for the applied one or more digital transformations.

12. The method of claim 11, wherein re-processing the at least one slice image further comprises:
removing at least one of one or more binary images or one or more greyscale images from the build file; and
replacing at least one of the at least one removed binary image or one removed greyscale image with the at least re-processed slice image in the plurality of slice images.

13. The method of claim 10, further comprising:
processing the build file by at least one of:
generating a plurality of slice images for the part to be included as part of the build file;
generating instructions for driving the additive manufacturing device for the part to be included as part of the build file; or
exporting the processed build file to a controller to operate the DLP printer.

14. The method of claim 10, wherein the one or more designated pixels comprise one or more pixels located at at least one of a geometric edge of the part or a smaller feature of the part.

15. The method of claim 10, wherein applying one or more digital transformations to a build file to provide an adjusted light intensity at one or more designated pixels of the image projected by the digital light projector further comprises utilizing a sequence of images for different exposure times to produce a single layer of the printed part.

16. The method of claim 10, wherein applying one or more digital transformations to a build file to provide an adjusted light intensity at one or more designated pixels of the image projected by the digital light projector further comprises utilizing an iterative approach that updates an educated determination about the light intensity to be used in conjunction with a transformed image of the build file to produce a single layer of the printed part.

17. A method of printing, comprising:
applying one or more digital transformations to a build file for a part to be printed to adjust a projected dosage of light at one or more designated pixels of an image to be projected in conjunction with printing the part to yield a desired dosage of light at the one or more designated pixels during printing, the desired dosage of light being based on a light intensity of an untransformed initial image intended to be supplied to one or more nearby pixels of the one or more designated pixels, and the desired dosage of light for the one or more designated pixels being inversely proportional to the intended light intensity for the one or more nearby pixels; and
performing digital light processing printing based on the build file to print the part.

18. The method of printing claim 17, wherein applying one or more digital transformations to a build file to provide an adjusted light intensity at one or more designated pixels of the image projected by the digital light projector further comprises utilizing a sequence of images for different exposure times to produce a single layer of the printed part.

19. The method of printing claim 17, wherein applying one or more digital transformations to a build file to provide an adjusted light intensity at one or more designated pixels of the image projected by the digital light projector further comprises utilizing an iterative approach that updates an educated determination about the light intensity to be used in conjunction with a transformed image of the build file to produce a single layer of the printed part.

20. The method of printing of claim 17, wherein applying one or more digital transformations to a build file to provide an adjusted light intensity at one or more designated pixels of the image projected by the digital light projector further comprises utilizing a machine-learning based approach that compares large datasets of transformed images and associated outcomes to make predictions for a transformed image of the build file to produce a single layer of the printed part.
